(19) United States
(12) Patent Application Publication
(10) Pub. No.: US 2004/0170238 A1
(43) Pub. Date: Sep. 2, 2004

(54) Frequency synchronizing method and frequency synchronizing apparatus

(76) Inventors: Koji Matsuyama, Kawasaki (JP); Makoto Yoshida, Kawasaki (JP); Tetsuya Yano, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/790,453

(22) Filed: Feb. 26, 2004

Related U.S. Application Data
(63) Continuation of application No. PCT/JP01/08488, filed on Sep. 28, 2001.

(51) Int. Cl. H04L 27/06

(52) U.S. Cl. 375/343

(57) ABSTRACT

A frequency synchronizing apparatus synchronizes the oscillation frequency of a receiving device to the oscillation frequency of a transmitting device. The frequency synchronizing apparatus receives, from the transmitting device, frames in which symbols having identical time profiles have been embedded, calculates a correlation value between the identical time profile portions in neighboring frames of a receive signal, obtains the phase of the correlation value (a complex number) as a frequency deviation between the transmitting device and the receiving device, and controls oscillation frequency based upon the phase.

### BACKGROUND OF THE INVENTION

This invention relates to a frequency synchronizing method and frequency synchronizing apparatus. More particularly, the invention relates to a frequency synchronizing method and frequency synchronizing apparatus in an OFDM wireless system for synchronizing the oscillation frequency of a receiving device to the oscillation frequency of a transmitting device.

Multicarrier modulation schemes have become the focus of attention as next-generation mobile communication schemes. Using multicarrier modulation not only makes it possible to implement wideband, highspeed data transmission but also enables the effects of frequency-selective fading to be mitigated by narrowing the band of each subcarrier. Further, using orthogonal frequency division multiplexing not only makes it possible to raise the efficiency of frequency utilization but also enables the effects of inter-symbol interference to be eliminated by providing a guard interval for every OFDM symbol.

(a) of FIG. 13 is a diagram useful in describing a multicarrier transmission scheme. A serial/parallel converter 1 converts serial data to parallel data and inputs the parallel data to orthogonal modulators 3a to 3d via low-pass filters 2a to 2d, respectively. In the Figure, the conversion is to parallel data comprising four symbols. Each symbol includes an in-phase component and a quadrature component. The orthogonal modulators 3a to 3d subject each symbol to orthogonal modulation by subcarriers having frequencies f₁ to f₄ illustrated in (b) of FIG. 13, a combiner 4 combines the orthogonally modulated signals and a transmitter (not shown) up-converts the combined signal to a high-frequency signal and then transmits the high-frequency signal. With the multicarrier transmission scheme, the frequencies are arranged, as shown at (b), in such a manner that the spectrums will not overlap in order to satisfy the orthogonality of the subcarriers.

In orthogonal frequency division multiplexing, frequency spacing is arranged so as to null the correlation between a modulation band signal transmitted by an nth subcarrier of multicarrier transmission and a modulation band signal transmitted by an (n+1)th subcarrier. (a) of FIG. 14 is a diagram of the structure of a transmitting apparatus that relies upon the orthogonal frequency division multiplexing scheme. A serial/parallel converter 5 converts serial data to parallel data comprising a plurality of symbols (I+jQ, which is a complex number). An IFFT (Inverse Fast Fourier Transform) 6, which is for the purpose of transmitting the symbols as subcarriers having a frequency spacing shown in (b) of FIG. 14, applies an inverse fast Fourier transform to the frequency data to effect a conversion to time data, and inputs the real and imaginary parts to an orthogonal modulator 8 through low-pass filters 7a, 7b. The orthogonal modulator 8 subjects the input data to orthogonal, and a transmitter (not shown) up-converts the modulated signal to a high-frequency signal. In accordance with orthogonal frequency division multiplexing, a frequency placement of the kind shown in (b) of FIG. 14 becomes possible, thereby enabling an improvement in the efficiency with which frequency is utilized.

In recent years, there has been extensive research in multicarrier CDMA schemes (MD-CDMA) and application thereof to next-generation wideband mobile communications is being studied. With MC-CDMA, partitioning into a plurality of subcarriers is achieved by serial-to-parallel conversion of transmit data and spreading of orthogonal codes in the frequency domain. Owing to frequency selective fading, subcarriers distanced by their frequency spacing are acted upon individually by independent fading. Accordingly, a despread signal can acquire frequency-diversity gain by causing code-spread subcarrier signals to be distributed along the frequency axis by frequency interleaving.

A CDMA (Code Division Multiple Access) scheme multiplies transmit data having a bit cycle Tₛ by spreading codes C₁ to C_{N} of chip frequency Tc using a multiplier 9, as shown in FIG. 15, modulates the result of multiplication and transmits the modulated signal. Owing to such multiplication, a 2/Tₛ narrow-band signal NM can be spread-spectrum modulated to a 2/Tc wideband signal DS and transmitted, as shown in FIG. 16. Here Ts/Tc is the spreading ratio and, in the illustrated example, is the code length N of the spreading code. In accordance with this CDMA transmission scheme, an advantage acquired is that an interference signal can be reduced to 1/N.

According to the principles of multicarrier CDMA, N-number of items of copy data are created by a single item of transmit data D, as shown in FIG. 17, the items of copy data are multiplied individually by respective ones of codes C₁ to C_{N}, which are spreading codes (orthogonal codes), using multipliers 9₁ to 9_{N}, respectively, and products DC₁ to DC_{N} undergo multicarrier transmission by N-number of subcarriers of frequencies f₁ to f_{N} illustrated in (a) of FIG. 18. The foregoing relates to a case where a single item of symbol data undergoes multicarrier transmission. In actuality, however, as will be described later, transmit data is converted to parallel data of M symbols, the M-number of symbols are subjected to the processing shown in FIG. 17, and all results of M×N multiplications undergo multicarrier transmission using M×N subcarriers of frequencies f₁ to fN_{M}. Further, orthogonal frequency/code division multiple access can be achieved by using subcarriers having the frequency placement shown in (b) of FIG. 18.

FIG. 19 is a diagram illustrating the structure on the transmitting side (base station) of MC-CDMA. A data modulator 11 modulates user transmit data and converts it to a complex baseband signal (symbol) having an in-phase component and a quadrature component. A time multiplexer 12 time-multiplexes the pilot of the complex symbol ahead of the transmit data. A serial/parallel converter 13 converts the input data to parallel data of M symbols, and each symbol is input to a spreader 14 upon being branched into N portions. The spreader 14 has M-number of multipliers 14₁ to 14ₙ. The multipliers 14₁ to 14ₙ multiply the branched symbols individually by codes C₁, C₂, . . . , C_{N} constituting orthogonal codes and output the resulting signals. As a result, subcarrier signals S₁ to S_{MN} for multicarrier transmission by N×M subcarriers are output from the spreader 14. That is, the spreader 14 multiplies the symbols of every parallel sequence by the orthogonal codes, thereby performing spreading in the frequency direction. Codes (Walsh codes) C₁, C₂, . . . C_{N} that differ for every user are indicated as the orthogonal codes used in spreading. In actuality, however, the subcarrier signals S₁ to S_{MN} are multiplied further by station identifying codes (Gold codes) G₁ to G_{MN}.

A code multiplexer 15 code-multiplexes the subcarrier signals generated as set forth above and the subcarriers of other users generated through a similar method. That is, for every subcarrier, the code multiplexer 15 combines the subcarrier signals of a plurality of users conforming to the subcarriers and outputs the result. A frequency interleaver 16 rearranges the code-multiplexed subcarriers by frequency interleaving, thereby distributing the subcarrier signals along the frequency axis, in order to obtain frequency-diversity gain. An IFFT (Inverse Fast Fourier Transform) unit 17 applies an IFFT (Inverse Fourier Transform) to the subcarrier signals that enter in parallel, thereby effecting a conversion to an OFDM signal (a real-part signal and an imaginary-part signal) on the time axis. A guard-interval insertion unit 18 inserts a guard interval into the OFDM signal, an orthogonal modulator applies orthogonal modulation to the OFDM signal into which the guard interval has been inserted, and a radio transmitter 20 up-converts the signal to a radio frequency, applies high-frequency amplification and transmits the resulting signal from an antenna.

The total number of subcarriers is (spreading ratio N)×(number M of parallel sequences). Further, since the propagation path is acted upon by fading that differs from subcarrier to subcarrier, a pilot is time-multiplexed onto all subcarriers and it is so arranged that fading compensation can be performed subcarrier by subcarrier on the receiving side. The time-multiplexed pilot is a pilot used in channel estimation.

FIG. 20 is a diagram useful in describing a serial-to-parallel conversion. Here a common pilot P has been time-multiplexed ahead of one frame of transmit data. It should be noted that the pilot P can also be dispersed within the frame. If the pilot per frame is

4×M symbols and the transmit data is 28×M symbols, then M symbols of the pilot will be output from the serial/parallel converter 13 as parallel data the first four times, and thereafter M symbols of the transmit data will be output from the serial/parallel converter 13 as parallel data 28 times. As a result, the pilot can be time-multiplexed into all subcarriers and transmitted four times in the duration of one frame. By using this pilot on the receiving side, the channel can be estimated subcarrier by subcarrier and channel compensation (fading compensation) becomes possible.

FIG. 21 is a diagram useful in describing insertion of a guard interval. If an IFFT output signal conforming to M×N subcarrier samples (=1 OFDM sample) is taken as one unit, then guard-interval insertion signifies copying the tail-end portion of this symbol to the leading-end portion thereof. Inserting a guard interval GI makes it possible to eliminate the effects of inter-symbol interference ascribable to multipath.

FIG. 22 is a diagram showing structure on the receiving side of MC-CDMA. A radio receiver 21 subjects a received multicarrier signal to frequency conversion processing, and an orthogonal demodulator subjects the receive signal to orthogonal demodulation processing. An OFDM symbol extraction unit 23 establishes receive-signal synchronization, then extracts one OFDM signal, from which the guard interval GI has been removed, from the receive signal and inputs the symbol to an FFT (Fast Fourier Transform) unit 24. The FFT unit 24 executes FFT processing at an FFT window timing, thereby converting a signal in the time domain to subcarrier signals of Nc (=N×M) samples in the frequency domain. A frequency deinterleaver 25 rearranges the subcarrier signals in an order opposite that on the transmitting side and outputs the signals in the order of the subcarrier frequencies.

After deinterleaving is carried out, a channel compensator 26 performs channel estimation on a per-subcarrier basis using the pilot time-multiplexed on the transmitting side and applies fading compensation. In the Figure, a channel estimation unit 26a₁ is illustrated only in regard to one subcarrier. However, such a channel estimation unit is provided for every subcarrier. That is, the channel estimation unit 26a₁ estimates the influence exp(jφ) of phase, which is ascribable to fading, using the pilot signal, and a multiplier 26b1 multiplies the subcarrier signal of the transmit symbol by exp(jφ) to compensate for fading.

A despreader 27 has M-number of multipliers 27₁ to 27M. The multiplier 27₁ multiplies N-number of subcarriers individually by codes C₁, C₂, . . . , C_{N} constituting orthogonal codes (Walsh codes) assigned to users and outputs the results. The other multipliers execute similar processing. As a result, the fading-compensated signals are despread by spreading codes assigned to each of the users, and signals of desired users are extracted from the code-multiplexed signals by despreading. In actuality, multiplication by station identifying codes (Gold codes) is performed before multiplication by the Walsh codes, though this is omitted here.

Combiners 28₁ to 28_{M} add the N-number of results of multiplication that are output from respective ones of the multipliers 27₁ to 27_{M}, thereby creating parallel data comprising M-number of symbols. A parallel/serial converter 29 converts this parallel data to serial data, and a data demodulator 30 demodulates the transmit data.

In communication that adopts the OFDM scheme, the frequency of a reference clock signal on the receiving side (the mobile station) must coincide with the frequency of the reference clock signal on the transmitting side (the base station). Usually, however, a frequency deviation Δf exists between the two. The frequency deviation Δf leads to interference between neighboring carriers and causes loss of orthogonality. This means that after the power supply of the receiving apparatus is turned on, it is necessary to apply AFC control immediately to reduce the frequency deviation and suppress interference.

FIG. 23 is a diagram showing the principal part of a receiving apparatus equipped with an AFC (Automatic Frequency Control) unit that causes the oscillation frequency of a local oscillator to agree with the frequency on the transmitting side. A high-frequency amplifier 31 amplifies the received radio signal, and a frequency converter/orthogonal demodulator 32 applies frequency conversion processing and orthogonal demodulation processing to the receive signal using a clock signal that enters from a local oscillator 33. An AD converter 34 subjects the orthogonal demodulated signal (I, Q complex signal) to an AD conversion, and the OFDM symbol extraction unit 23 extracts one OFDM symbol, from which the guard interval GI has been removed, and inputs the resultant signal to the FFT (Fast Fourier Transform) unit 24. The latter executes FFT processing at an FFT window timing, thereby converting a signal in the time domain to a signal in the frequency domain. An AFC unit 35 detects the phase θ conforming to the frequency deviation Δf using the receive data, which is the complex signal that enters from the AD converter, and inputs an AFC control signal conforming to this phase to the local oscillator 33, whereby the oscillation frequency is made to agree with the oscillation frequency on the transmitting side. That is, the AFC unit 35 calculates a correlation value between a time profile in a guard interval that has been attached to an OFDM symbol, and a time profile of an OFDM symbol portion that has been copied to a guard interval, obtains the phase of the correlation value (complex number) as the frequency deviation Δf between the transmitting apparatus and receiving apparatus, and controls the oscillation frequency based upon this phase to match the oscillation frequency on the transmitting side.

Though the frequency deviation can be pulled into a certain frequency-error range by AFC control using the correlation value of the guard interval, there are also cases where further suppression of the carrier-frequency deviation is required. When the frequency error becomes small, however, the amount of phase rotation per OFDM symbol time diminishes and therefore accuracy declines owing to quantization error in the digital circuitry. Consequently, there is a limit to suppression of frequency deviation by detecting a phase difference for every OFDM symbol.

### SUMMARY OF THE INVENTION

Accordingly, an object of the present invention is to reduce the frequency deviation between an OFDM transmitter and an OFDM receiver.

Another object of the present invention is to enlarge detected phase difference, even if the frequency deviation is small, thereby improving resolution and S/N ratio to enable highly precise control of frequency deviation.

Disclosure of the Invention

A first frequency synchronizing apparatus according to the present invention synchronizes the oscillation frequency of a receiving device to the oscillation frequency of a transmitting device. The apparatus receives, from the transmitting device, frames in which symbols having identical time profiles have been embedded, calculates a correlation value between the identical time profile portions in neighboring frames of a receive signal, obtains the phase of the correlation value as a frequency deviation between the transmitting device and the receiving device, and controls oscillation frequency based upon the phase. In accordance with this frequency synchronizing apparatus, frequency is controlled upon detecting a phase generated in a frame interval that is long in comparison with a symbol interval. As a result, even if the phase is small in the symbol interval, it can be enlarged in the frame interval, resolution and S/N ratio are improved and the oscillation frequency of the receiving apparatus can be made to agree with that of the transmitting apparatus in highly accurate fashion.

A second frequency synchronizing apparatus according to the present invention receives, from the transmitting device, frames in which n-number of first to nth symbols having prescribed time profiles have been embedded, calculates and sums correlation values of time profile portions of corresponding symbols among n sets of symbols in neighboring frames of a receive signal, obtains the phase of the sum value as a frequency deviation between the transmitting device and the receiving device, and controls the oscillation frequency based upon the phase. In accordance with the second frequency synchronizing apparatus, the S/N ratio can be improved further and the oscillation frequency of the receiving apparatus can be made to agree with that of the transmitting apparatus in highly accurate fashion in a short period of time.

A third frequency synchronizing apparatus according to the present invention (1) receives, from the transmitting device, frames having a plurality of symbols in which a guard interval has been inserted and in which symbols having identical time profiles have been embedded; (2) calculates a correlation value between a time profile in a guard interval and a time profile of a symbol portion that has been copied to a guard interval, obtains the phase of this correlation value as a frequency deviation between the transmitting device and the receiving device and controls the oscillation frequency up to a first precision based upon this phase; and (3) thenceforth calculates a correlation value between identical time profile portions in neighboring frames of a receive signal, obtains the phase of this correlation value as a frequency deviation between the transmitting device and the receiving device and controls the oscillation frequency up to a higher second precision based upon this phase. In accordance with the third frequency synchronizing apparatus, frequency can be controlled up to a first precision at high speed by a first control method, after which resolution and S/N ratio can be improved and frequency controlled in highly accurate fashion by a second control method.

A fourth frequency synchronizing apparatus according to the present invention (1) receives, from the transmitting device, frames having a plurality of symbols in which a guard interval has been inserted and in which n-number of first to nth symbols having prescribed time profiles have been embedded; (2) calculates a correlation value between a time profile in the guard interval and a time profile of a symbol portion that has been copied to a guard interval, obtains the phase of this correlation value as a frequency deviation between the transmitting device and the receiving device and controls the oscillation frequency up to a first precision based upon this phase; and (3) thenceforth calculates and sums correlation values of time profile portions of corresponding symbols among n sets of symbols in neighboring frames of a receive signal, obtains the phase of the sum as a frequency deviation between the transmitting device and the receiving device, and controls the oscillation frequency up to a higher second precision based upon this phase. In accordance with the fourth frequency synchronizing apparatus, frequency can be controlled up to a first precision at high speed by a first control method, after which S/N ratio can be improved and frequency controlled in highly accurate fashion by a second control method.

### BRIEF DESCRIPTION OF THE DRAWINGS

FIG. 1 is a diagram useful in describing the principles of the present invention;

FIG. 2 is a block diagram of a principal portion of a first embodiment of the present invention;

FIG. 3 is a block diagram of a first AFC unit;

FIG. 4 is a diagram useful in describing operation of the first AFC unit;

FIG. 5 is a diagram useful in describing a case where correlation includes a phase θ owing to frequency deviation;

FIG. 6 is a block diagram of a peak detector;

FIG. 7 is a block diagram of a second AFC unit;

FIG. 8 is a diagram useful in describing operation of the second AFC unit;

FIG. 9 is another block diagram of the second AFC unit;

FIG. 10 is another diagram useful in describing operation of the second AFC unit;

FIG. 11 shows another example of placement of symbols having an identical time profile;

FIG. 12 is a block diagram of a third embodiment;

FIG. 13 is a diagram useful in describing a multicarrier transmission scheme according to the prior art;

FIG. 14 is a diagram useful in describing an orthogonal frequency division multiplexing scheme according to the prior art;

FIG. 15 is a diagram useful in describing code spreading modulation in CDMA;

FIG. 16 is a diagram useful in describing spreading of a band in CDMA;

FIG. 17 is a diagram useful in describing the principle of a multicarrier CDMA scheme;

FIG. 18 is a diagram useful in describing placement of subcarriers;

FIG. 19 is a block diagram of a transmitting side in MC-CDMA according to the prior art;

FIG. 20 is a diagram useful in describing a serial-to-parallel conversion;

FIG. 21 is a diagram useful in describing a guard interval;

FIG. 22 is a block diagram of a receiving side in MC-CDMA according to the prior art; and

FIG. 23 is a block diagram of frequency control according to the prior art.

### DESCRIPTION OF THE PREFERRED EMBODIMENTS

(A) Principles of the Present Invention

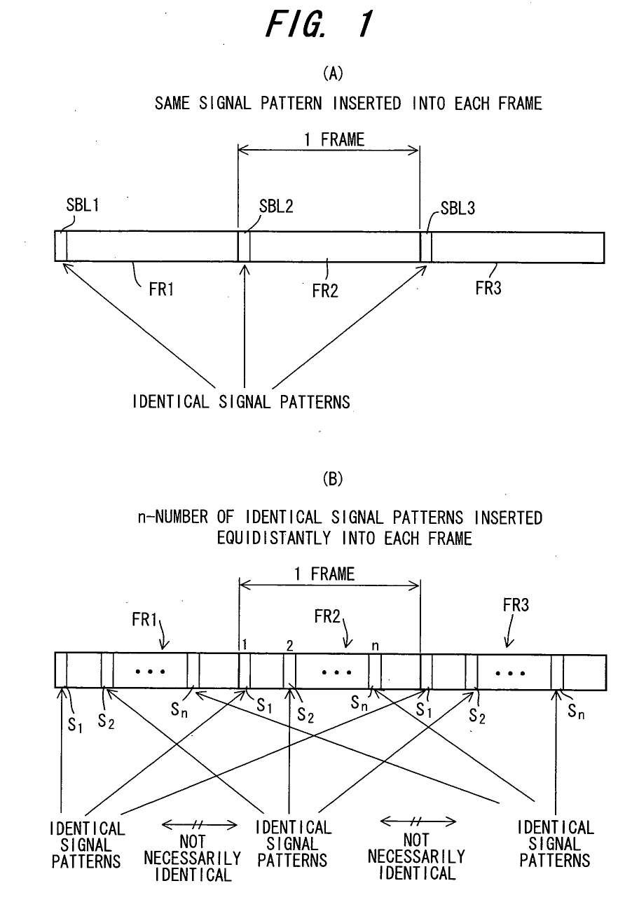

As shown in (A) of FIG. 1, a transmitting device inserts OFDM symbols SBL1 to SBL3 having the same time profile (the same signal pattern in relation to time) into the same locations of frames FR1 to FR3 each composed of a plurality of OFDM symbols and transmits the frames upon performing orthogonal frequency division multiplexing. After having its power supply turned on, a receiving device first synchronizes it oscillation frequency to the oscillation frequency of the transmitting device by AFC control, then applies FFT processing to the receive signal and demodulates the transmit data.

AFC control is executed by a frequency synchronizing unit in the receiving device. The frequency synchronizing unit (1) calculates a correlation value (a complex number) between the identical time profile portions (OFDM symbols) SBL1, SBL2 that have been embedded in the same locations of two mutually adjacent frames FR1, FR2 of the receive signal; (2) obtains the phase θ of this correlation value as a frequency deviation Δf between the transmitting device and the receiving device, and (3) control the oscillation frequency based upon this phase. More specifically, the receive signal can be extracted as a complex signal by orthogonal demodulation. If the frequency deviation Δf exists, the phase difference θ is produced between the receive signal in the initial OFDM symbol SBL1 and the receive signal in the next OFDM symbol SBL2, where SBL1, SBL2 are the identical time profile portions. As a result, the correlation value between the identical time profile portions (OFDM symbols) SBL1, SBL2 becomes a complex signal having the phase θ. Accordingly, the phase θ is obtained from the correlation value as the frequency deviation Δf between the transmitting device and the receiving device, and the oscillation frequency is controlled based upon this phase.

If the arrangement described above is adopted, frequency is controlled upon detecting a phase generated in a frame interval that is long in comparison with a symbol interval. As a result, even if the phase is small in the symbol interval, it can be enlarged in the frame interval, resolution and S/N ratio are improved and the oscillation frequency of the receiving apparatus can be made to agree with that of the transmitting apparatus in highly accurate fashion.

Further, if n-number of first to nth symbols having prescribed time profiles are transmitted upon being embedded in each of frames FR1 to FR3, as shown in (B) of FIG. 1, then correlation between n-number of corresponding time profile portions of neighboring frames are calculated and summed, whereby the S/N ratio can be improved further and the oscillation frequency of the receiving device can be made to agree with that of the transmitting apparatus in highly accurate fashion in a short period of time. More specifically, the frequency synchronizing unit (1) receives, from the transmitting device, frames FR1 to FR3 in which n-number of first to nth symbols S1 to Sn having prescribed time profiles have been embedded; (2) calculates and sums correlation (complex numbers) of n sets of of corresponding time profile portions S1 to Sn of two mutually adjacent frames FR1, FR2 of the receive signal; and (3) obtains the phase of the sum as a frequency deviation between the transmitting device and the receiving device, and controls the oscillation frequency based upon this phase.

It should be noted that time profiles (signal patterns) of the n-number of first to nth symbols S1 to Sn may all be the same or may all be different. It is preferred, however, that ith symbols Si (i=1 to n) in each of the frames all have the same positions in the frames.

(B) First Embodiment

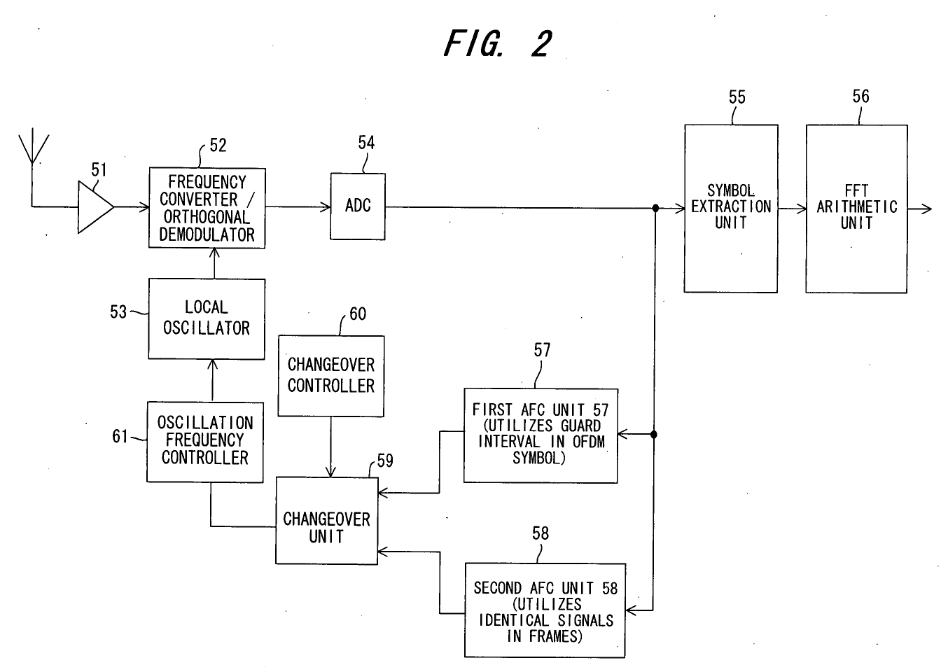

FIG. 2 is a block diagram of a principal portion of a first embodiment of the present invention. A high-frequency amplifier 51 amplifies a received radio signal, and a frequency converter/orthogonal demodulator 52 applies frequency conversion processing and orthogonal demodulation processing to the receive signal using a clock signal that enters from a local oscillator 53. An AD converter 54 subjects the orthogonal demodulated signal (I, Q complex signal) to an AD conversion, and an OFDM symbol extraction unit 55 extracts one valid OFDM symbol, from which the guard interval GI has been removed, and inputs the resultant signal to an FFT (Fast Fourier Transform) unit 56. Hereafter, an OFDM symbol that does not contain a guard interval GI shall be referred to as a valid OFDM symbol, and one that contains a guard interval GI shall be referred to as an OFDM symbol.

The FFT unit 56 executes FFT processing at an FFT window timing, thereby converting a signal in the time domain to a signal in the frequency domain. First and second AFC units 57, 58 each detect a frequency deviation by a correlation operation using receive data, which is the complex signal that enters from the AD converter 54, and each inputs an AFC control signal, which conforms to the frequency deviation, to an oscillation frequency controller 61, whereby the frequency of a clock signal that is output from the local oscillator 53 is made to agree with the oscillation frequency on the transmitting side.

More specifically, the first AFC unit 57 calculates a correlation value (complex number) between the time profile of a guard interval that has been added onto an OFDM symbol and the time profile of an OFDM symbol portion that has been copied to a guard interval, obtains the phase of the correlation value as the frequency deviation Δf between the transmitting and receiving devices, and controls the oscillation frequency based upon this phase to match the oscillation frequency on the transmitting side. As a result, a frequency deviation of ±1 ppm can be pulled to within ±0.1 ppm in several seconds.

The second AFC unit 58 calculates a correlation value (complex number) between the identical time-profile portions (OFDM symbols) SBL1, SBL2 that have been embedded in the same locations of two mutually adjacent frames FR1, FR2 [see FIG. 1(A)] of the receive signal, obtains the phase of the correlation value as the frequency deviation Δf between the transmitting and receiving devices, and controls the oscillation frequency based upon this phase to match the oscillation frequency on the transmitting side. In a case where the frequency deviation is ±0.1 ppm, the amount of phase rotation per frame time (0.5 msec) is ±90°, whereas the amount of phase rotation per one valid OFDM symbol time is ±2.35°. Accordingly, even in a case where a satisfactory phase detection accuracy is not obtained owing to a limitation imposed upon bit width by the AD conversion, the second AFC unit 58 is capable of improving the resolution of phase detection by utilizing the phase difference between frames. As a result, the second AFC unit 58 is capable of pulling a frequency deviation of ±0.1 ppm into a range of ±0.01 to ±0.05 ppm.

In accordance with a command from a changeover controller 60, a changeover unit 59 selects the AFC signals output from the first and second AFC units 57, 58 and inputs the selected signal to the oscillation frequency controller 61. On the basis of the AFC signal applied thereto, the oscillation frequency controller 61 exercises control in such a manner that the frequency of the clock that is output from the local oscillator 53 will agree with the oscillation frequency of the transmitting device. The changeover controller 60 controls the changeover unit 59 so as to (1) select the AFC signal output of the first AFC unit 57 when the power supply is turned on, and (2) select the AFC signal output of the second AFC unit 58 when the frequency deviation falls below a set level owing to control by the first AFC unit 57, or when a set period of time elapses following the start of control by the first AFC unit 57.

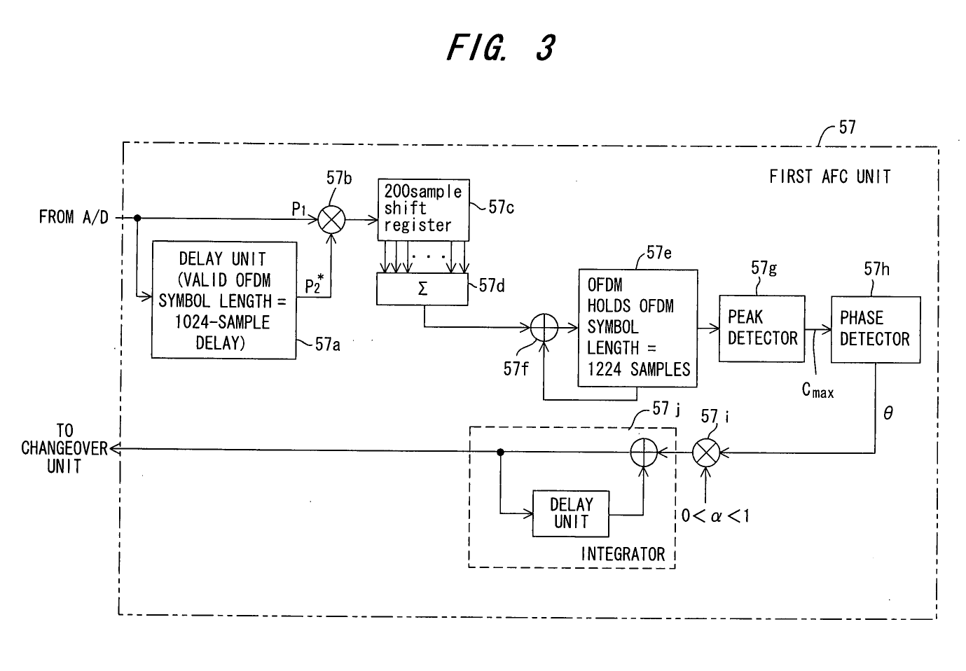

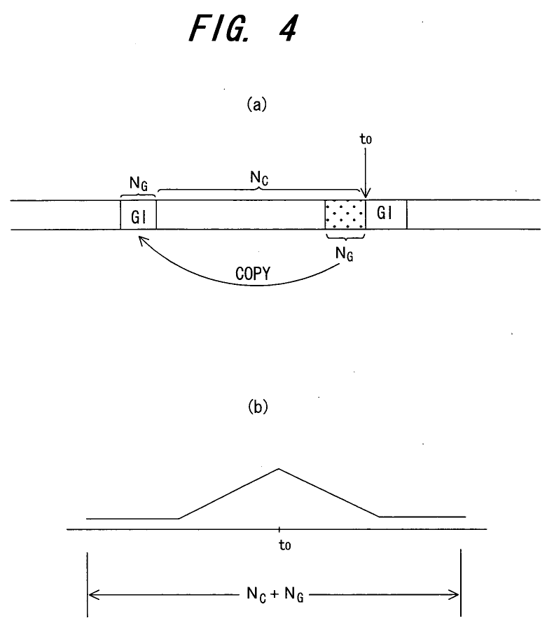

FIG. 3 is a block diagram of the first AFC unit 57, and FIG. 4 is a diagram useful in describing the operation of the first AFC unit 57.

A guard interval GI is created by copying a tail-end portion, which is composed of N_{G}-number of samples, of a valid OFDM symbol to the leading-end portion of the valid OFDM symbol, which is composed of N_{C}-number of samples, as illustrated in (a) of FIG. 4. Therefore, by calculating the correlation between the receive signal that prevailed one valid OFDM symbol earlier (N_{C} samples earlier) and the currently prevailing receive signal, the correlation value is maximized at the portion of the guard interval GI, as illustrated in (b) of FIG. 4. Since this maximum correlation value is a value having a phase that is dependent upon the frequency deviation, the phase, namely the frequency deviation, can be detected by detecting the maximum correlation value.

In FIG. 3, a delay unit 57a delays the receive signal by one valid OFDM symbol (sample count N_{C}=1024), and a multiplier 57b multiplies the complex conjugate P₂* of a receive signal P₂ prevailing one valid OFDM symbol earlier by the currently prevailing receive signal P₁ and outputs the result of multiplication. A shift register 57c has a length equivalent to the N_{G}-number of samples (=200 samples) of the guard interval and stores N_{G}-number of the latest results of multiplication, and an adder 57d adds the N_{G}-number of multiplication. results and outputs a correlation value having a width of N_{G}-number of samples. A correlation-value storage unit 57e stores (N_{G}+N_{C}) (=1224) correlation values, staggered one sample at a time, output from the adder 57d. An adder 57f sums the correlation values over 32 symbols within a frame and over several frames in order to raise the S/N ratio and stores the sum in the correlation-value storage unit 57e.

Ideally, the receive signal that prevailed one valid OFDM symbol earlier and the currently prevailing receive signal are the same in the guard interval time. Therefore, the correlation values gradually increase, as depicted in (b) of FIG. 4, as the number of results of multiplication of the guard interval stored in the shift register 57c increase. When all N_{G}-number of multiplication results in the guard interval have been stored in the shift register 57c, the correlation value reaches it maximum. Thereafter, the number of results of multiplication of the guard interval stored in the shift register 57c decrease and the correlation values gradually decline.

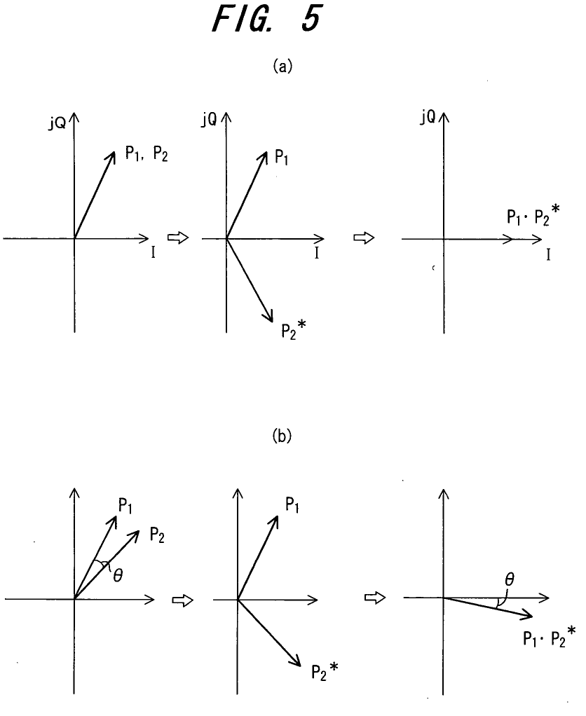

Further, if noise is zero when the frequency offset Δf=0 holds, P₁ and P₂ become identical vectors, as shown in (a) of FIG. 5, and the output P₁·P₂* of the multiplier 57b becomes a real number. However, if noise is zero when the frequency deviation Δf=a holds, then P₁ and P₂ will not be identical vectors, as shown in (b) of FIG. 5, and phase rotation θ conforming to the frequency deviation Δf is produced between P₁ and P₂ As a result, the output P₁·P₂* of the multiplier 57b is rotated by θ and becomes a complex number in comparison with the case where Δf=0 holds.

In view of the foregoing, the correlation values output from the adder 57d peak when all N_{G}-number of results of multiplication in the guard interval time have been stored in the shift register 57c, and this maximum value is a complex number having a phase difference θ conforming to the frequency offset Δf.

A peak detector 57g detects a peak correlation value Cmax of maximum correlation power from among the (N_{G}+N_{C})-number of correlation values that have been stored in the correlation-value storage unit 57e, and a phase detector 57h calculates the phase θ in accordance with the following equation using a real part Re[Cmax] and an imaginary part Im[Cmax] of this correlation value (complex number):

θ=tan⁻¹{Im[Cmax]/Re[Cmax]} (1)

Since the phase θ is produced by the frequency deviation Δf, it is fed back as the control signal of the local oscillator 53 based upon the phase θ. It should be noted that by multiplying the phase θ by a variable damping coefficient α (0<α<1) using a multiplier 57i, control is performed so as not to follow up momentary response. Further, the AFC signal is input to the oscillation frequency controller 61 upon being integrated and smoothed by an integrator 57j, thereby controlling the frequency of the clock signal that is output from the local oscillator 33.

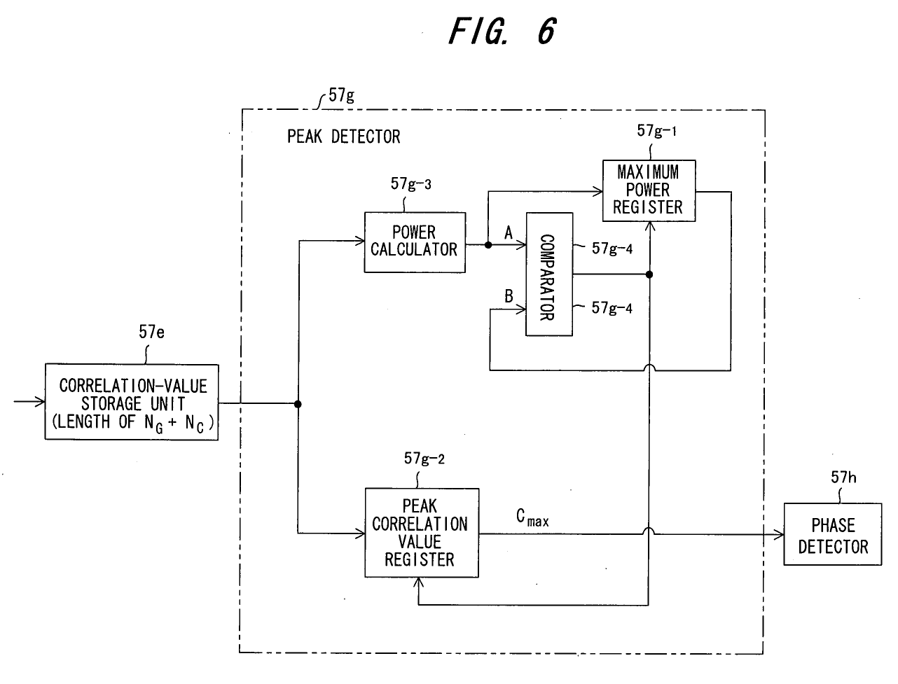

FIG. 6 is a block diagram of the peak detector. In the correlation-value storage unit 57e, which is the preceding stage, (N_{G}+N_{C})-number of correlation values have been stored. The peak detector 57g detects and outputs the peak correlation value of maximum power from among these values. Initially, a maximum power register 57g-1 and a peak correlation value register 57g-2 are cleared. Under these conditions, a power calculator 57g-3 calculates power A of the initial correlation value from the correlation-value storage unit 57e, and a comparator 57g-4 compares the magnitude of the power A and the magnitude of maximum power B, which has been stored in the maximum power register 57g-1. If A>B holds, the power A is stored in the maximum power register 57g-1 and the correlation value prevailing at this time is stored in the peak correlation value register 57g-2. When the above operation has subsequently been repeated for all of the (N_{G}+N_{C})-number of correlation values that have been stored in the correlation-value storage unit 57e, the correlation value that will have stored in the peak correlation value register 57g-2 will be the peak correlation value Cmax of maximum power. The phase detector 57h calculates the phase θ in accordance with Equation (1) using this peak correlation value.

Thus, the frequency control operation of the first AFC unit 57 allows a frequency deviation of ±1 ppm to be pulled to within ±0.1 ppm in several seconds.

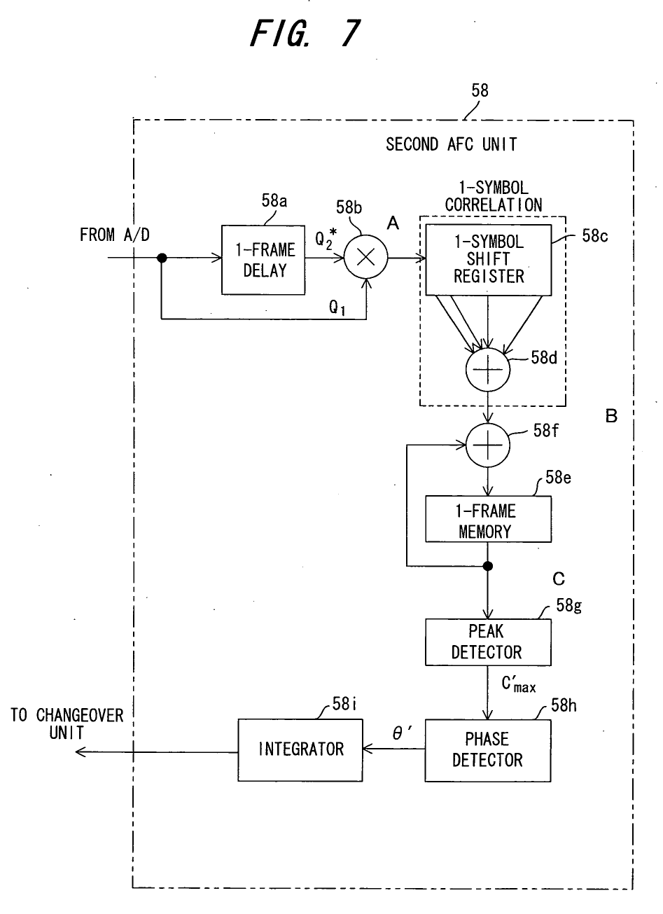

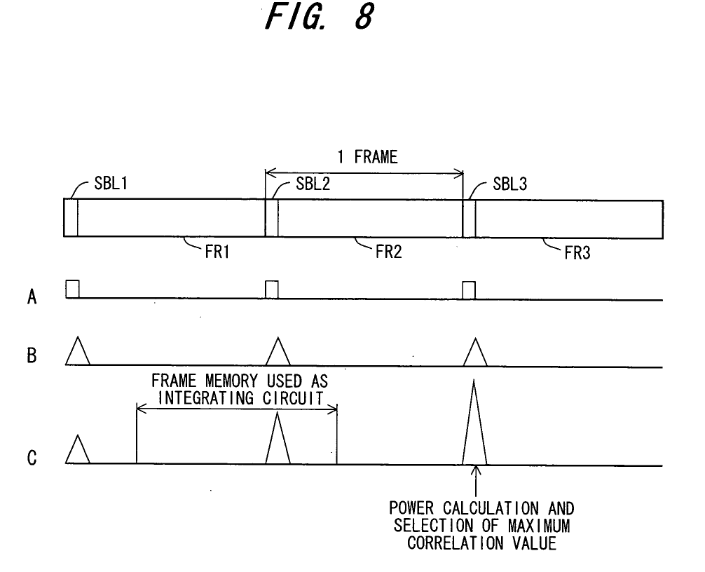

FIG. 7 is a block diagram of the second AFC unit 58, which has a structure similar to that of the first AFC unit 57. As illustrated in FIG. 8, identical time profile portions (identical signal patterns) SBL1, SBL2, SBL3 have been embedded over one OFDM symbol time in identical locations of frames FR1, FR2, FR3. Accordingly, by calculating the correlation between the receive signal one frame earlier and the receive signal of the present frame, the correlation value will reach its maximum at the locations of the embedded symbols. Since the maximum correlation value becomes a value having a phase that is dependent upon the frequency deviation, the phase, i.e., the frequency deviation, can be detected by detecting the maximum correlation value.

In FIG. 7, a delay unit 58a delays the receive signal by one frame [32×(N_{G}+N_{C})=32×1224 samples], and a multiplier 58b multiplies the complex conjugate Q₂* of a receive signal Q₂ prevailing one frame earlier by the currently prevailing receive signal Q₁ and outputs a result A of multiplication. A shift register 58c has a length equivalent to one OFDM symbol [(N_{G}+N_{C})=1224 samples] and stores (N_{G}+N_{C})-number of the latest results of multiplication, and an adder 58d adds the (N_{G}+N_{C})-number of multiplication results and outputs a correlation value B having a width of one symbol. A correlation-value storage unit 58e stores one frame's worth [32×(N_{G}+N_{C})=32×1224] of correlation values, staggered one sample at a time, output from the adder 58d. An adder 58f sums the correlation values over a plurality of frames in order to raise the S/N ratio and stores the sum in the correlation-value storage unit 58e.

The correlation value B output from the adder 58d reaches it maximum when all (N_{G}+N_{C})-number of multiplication results in one OFDM symbol interval in which identical time profiles have been embedded has been stored in the shift register 58c(see B in FIG. 8). This maximum value is a complex number having a phase difference θ conforming to the frequency offset Δf. The correlation values B are summed by an adder 58f over a plurality of frames, thereby producing an increasing signal, as illustrated at C in FIG. 8, and improving the S/N ratio.

A peak detector 58g detects a peak correlation value C′max of maximum correlation power from among the [32×(N_{G}+N_{C})=32×1224]-number of correlation values that have been stored in the correlation-value storage unit 58e, and a phase detector 58h calculates the phase θ′ in accordance with the following equation using a real part Re[C′max] and an imaginary part Im[C′max] of this correlation value (complex number):

θ=tan⁻¹{Im[C′max]/Re[C′max]} (1)′

Since the phase θ′ is produced by the frequency deviation Δf, the phase θ′ is regarded as the frequency deviation Δf, integration and smoothing are performed by an integrator 58i, and the AFC signal is input to the oscillation frequency controller 61 (FIG. 2), thereby controlling the frequency of the clock signal that is output from the local oscillator 53. The frequency deviation can be pulled into a range of ±0.01 to ±0.05 ppm by frequency control performed by the second AFC unit 58.

Thus, in accordance with the first embodiment, a frequency deviation of ±1 ppm can be pulled to within ±0.1 ppm in several seconds by frequency control in the first AFC unit 57, after which the frequency deviation can be pulled into a range of ±0.01 to ±0.05 ppm by frequency control in the second AFC unit 58. In other words, the second AFC unit 58 can improve the resolution of phase detection by utilizing the phase difference between frames, thereby making it possible to pull the frequency deviation into a range of ±0.01 to ±0.05 ppm.

(C) Second Embodiment

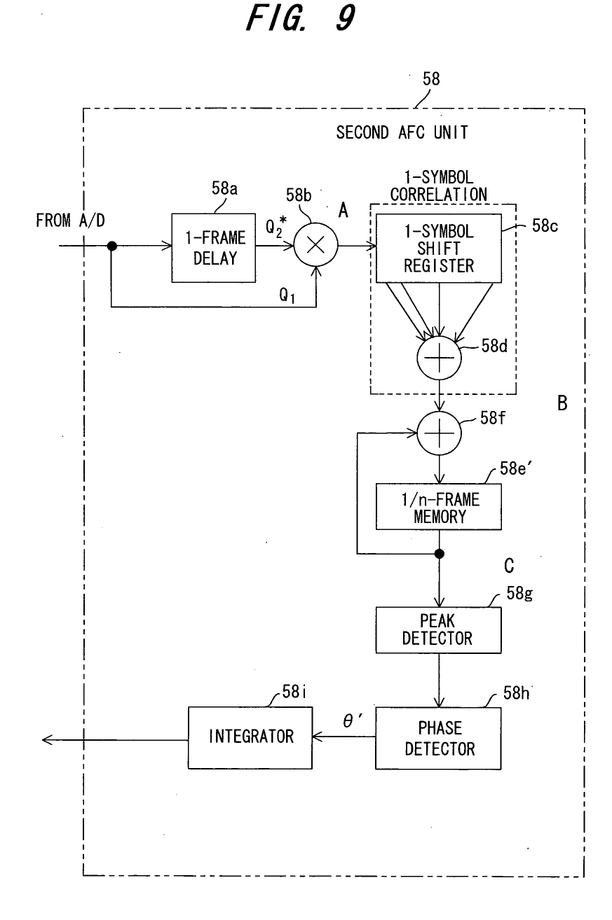

The second AFC unit 58 in the first embodiment represents an embodiment of a case where the same time profile (signal pattern) of one symbol duration is embedded in each frame. Here, however, as illustrated in FIG. 1(B), transmission is performed upon embedding n-number of first to nth symbols S₁ to Sₙ, which have prescribed time profiles, at an equal spacing in each of frames FR1 to FR3 in order to improve the S/N ratio. FIG. 9 is an embodiment of the second AFC unit 58 in such case. Here components identical with those of the first embodiment in FIG. 7 are designated by like reference characters. This embodiment differs in the follows respects:

(1) a correlation-value storage unit 58e′ having a storage capacity of 1/n frame's worth [32×(N_{G}+N_{C})/n] of correlation values is provided instead of the correlation-value storage unit 58e having the storage capacity of one frame's worth [32×(N_{G}+N_{C})=32×1224] of correlation values of the first embodiment;

(2) the correlation values (complex numbers) of n sets of corresponding time profile portions S1 to Sn of two mutually adjacent frames FR1, FR2 are summed in the correlation-value storage unit 58e′; and

(3) the phase of the sum is obtained as the frequency deviation between the transmitting and receiving devices and the oscillation frequency is controlled based upon this phase.

The delay unit 58a delays the receive signal by one frame [32×(N_{G}+N_{C})=32×1224 samples], and the multiplier 58b multiplies the complex conjugate Q₂* of the receive signal Q₂ prevailing one frame earlier by the currently prevailing receive signal Q₁ and outputs the result A of multiplication. The shift register 58c has a length equivalent to one OFDM symbol [(N_{G}+N_{C})=1224 samples] and stores (N_{G}+N_{C})-number of the latest results of multiplication, and the adder 58d adds the (N_{G}+N_{C})-number of multiplication results and outputs a correlation value B having a width of one symbol. The correlation-value storage unit 58e′ stores 1/n frame's worth [32×(N_{G}+N_{C})/n=32×1224/n] of correlation values, staggered one sample at a time, output from the adder 58d. The adder 58f sums the 1/n frame's worth of correlation values n times per frame and stores the sum in the correlation-value storage unit 58e′. As a result, according to the second embodiment, an S/N ratio that corresponds to n frame's worth of correlation calculation of the first embodiment can be obtained by one frame of correlation calculation.

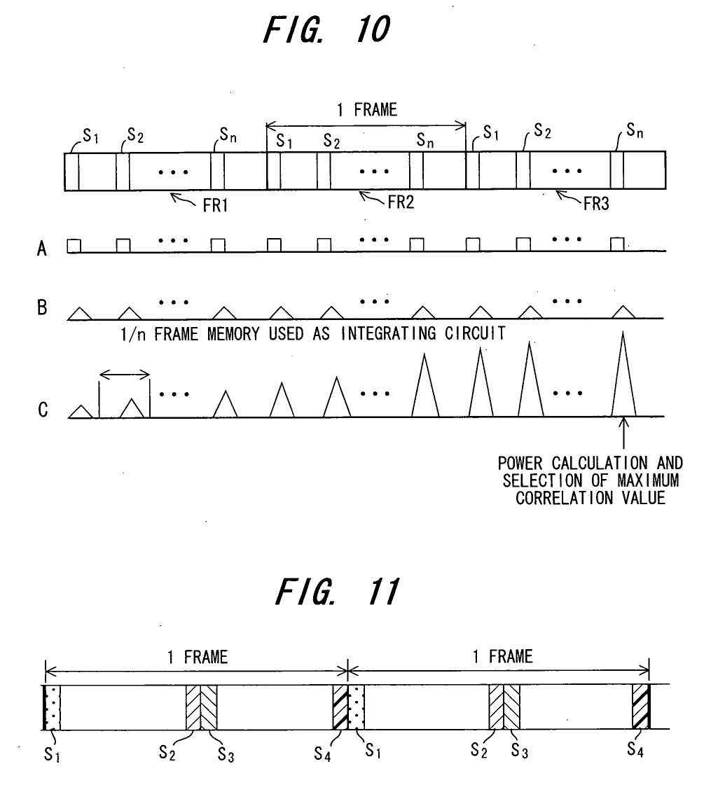

The correlation value B output from the adder 58d reaches it maximum when all (N_{G}+N_{C})-number of multiplication results in one OFDM symbol interval in which identical time profiles have been embedded has been stored in the shift register 58c(see B in FIG. 10). The correlation values B are summed by the adder 58f over one to a plurality of frames at a period of 1/n frame, thereby producing an increasing signal, as illustrated at C in FIG. 10, and improving the S/N ratio.

A peak detector 58g detects a peak correlation value of maximum correlation power from among the 1/n frame's worth [32×(N_{G}+N_{C})/n=32×1224/n] of correlation values (complex numbers) that have been stored in the correlation-value storage unit 58e′, and the phase detector 58h calculates the phase θ′ using the real and imaginary parts of the peak correlation value. Since the phase θ′ is produced by the frequency deviation Δf, the phase θ′ is regarded as the frequency deviation Δf, integration and smoothing are performed by the integrator 58i, and the AFC signal is input to the oscillation frequency controller 61 (FIG. 2), thereby controlling the frequency of the clock signal that is output from the local oscillator 53.

In accordance with the second embodiment, the correlation between n sets of corresponding time profile portions is calculated and the correlation values are summed, thereby enabling a further improvement in S/N ratio as compared with the first embodiment and making it possible to synchronize the oscillation frequency of the receiving device to that of the transmitting device in highly precision fashion and in a short period of time.

The foregoing is a case where n-number of first to nth symbols S1 to Sn are embedded at equal intervals. As illustrated in FIG. 11, however, the symbols need not be provided at equal intervals. In terms of the correlation calculations, however, it is preferred that symbols having identical time profiles (signal patterns) be embedded at the same locations in each of the frames.

(D) Third Embodiment

The second embodiment is for a case where the first and second AFC units 57, 58 are provided, frequency control of coarse precision is executed first by the first AFC unit 57, and then frequency control of high precision is executed by the second AFC unit 58. However, frequency control can be performed solely by the second AFC unit 58 under conditions where the frequency deviation is small.

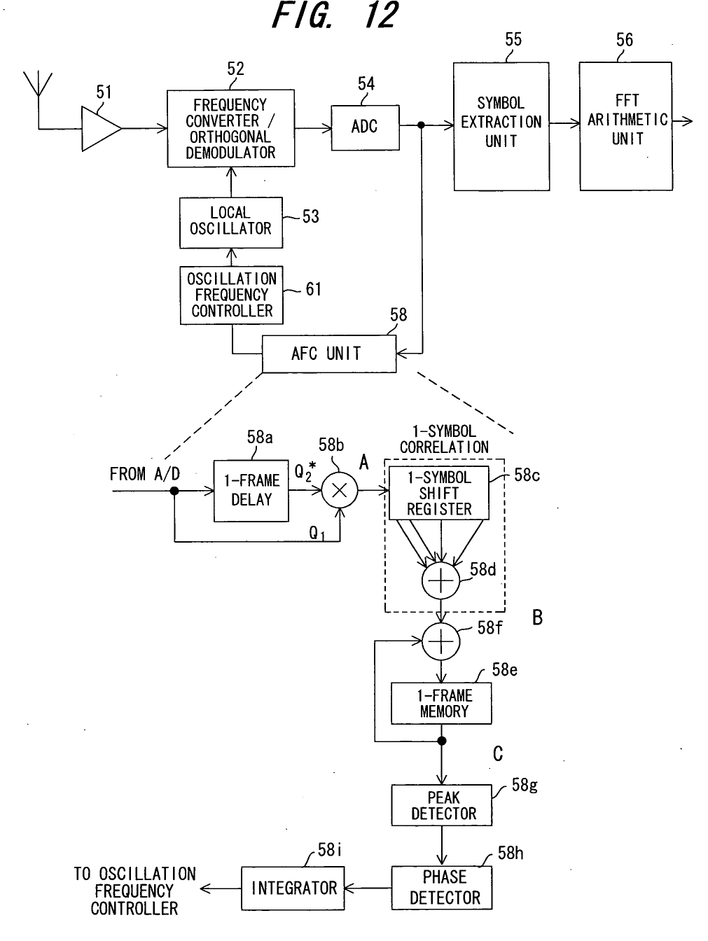

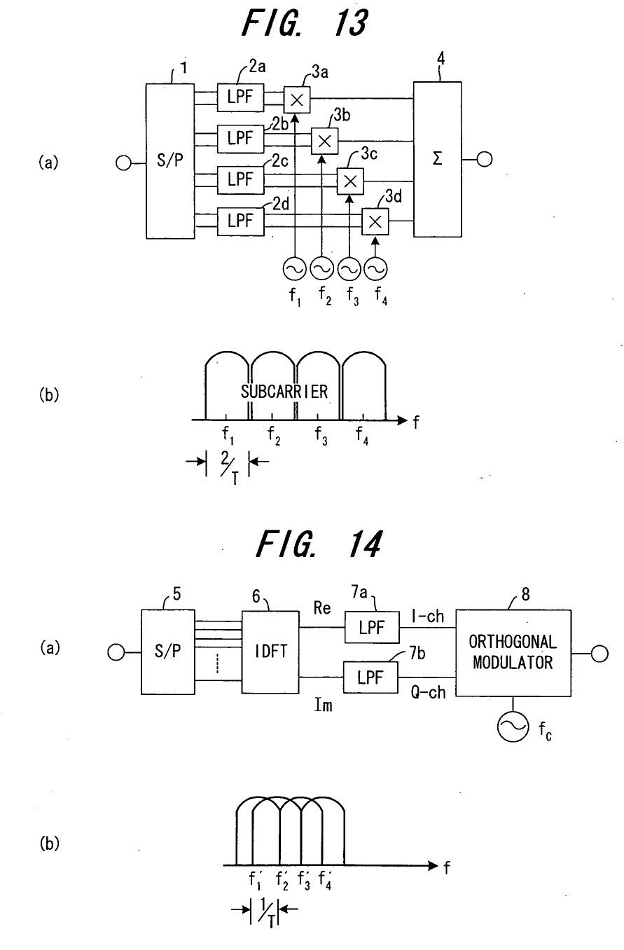

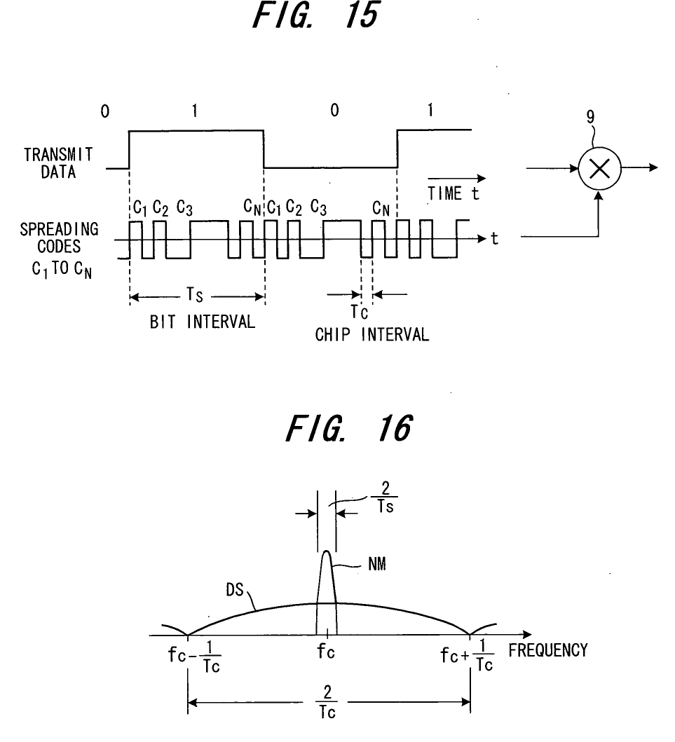

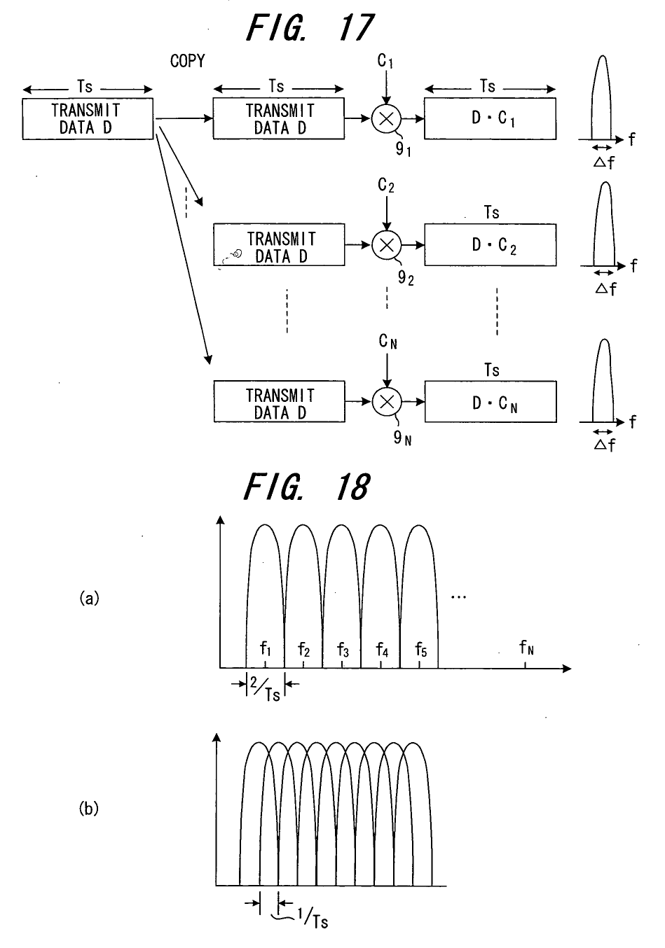

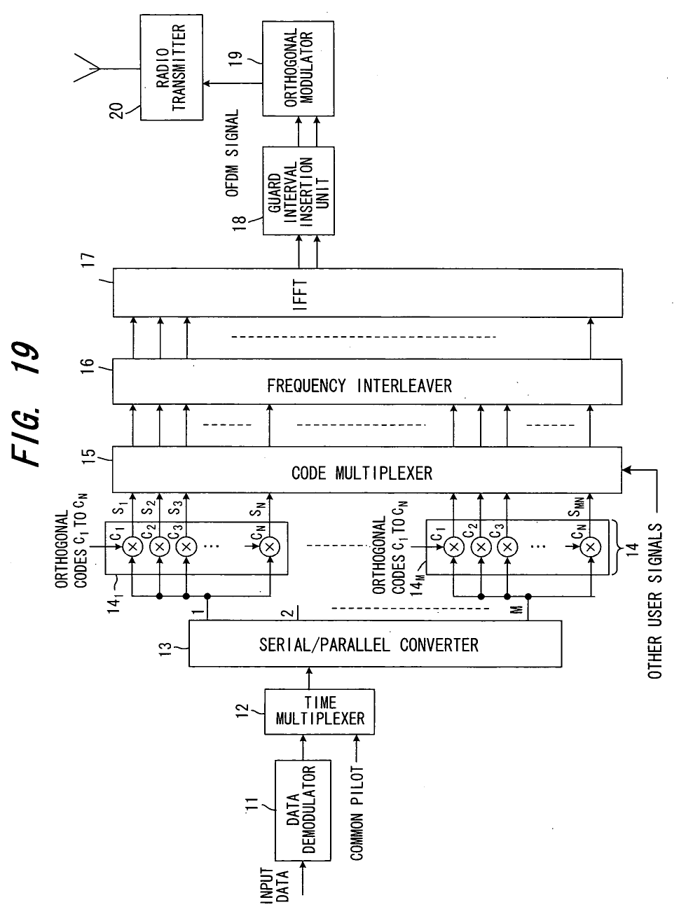

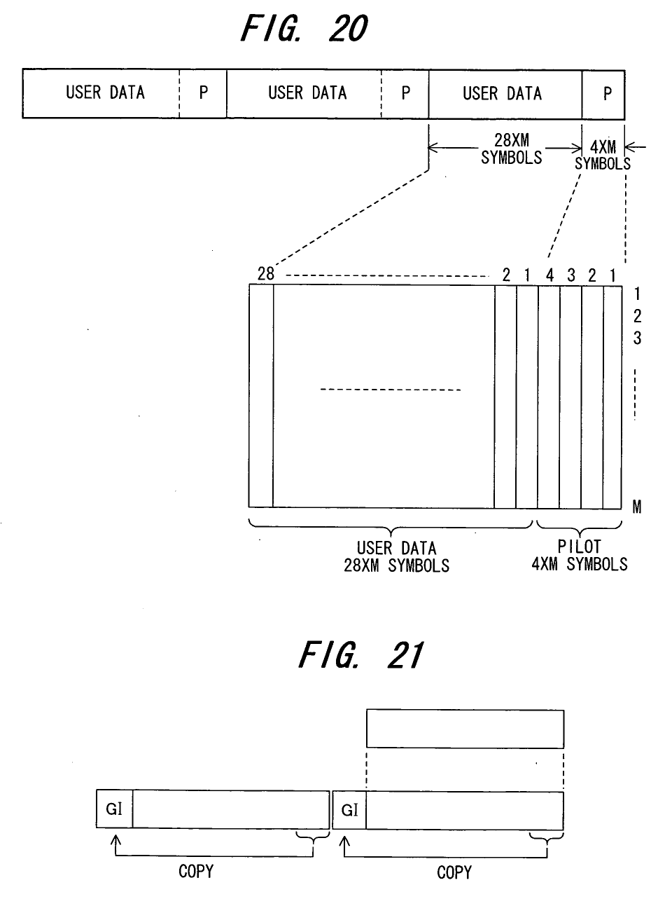

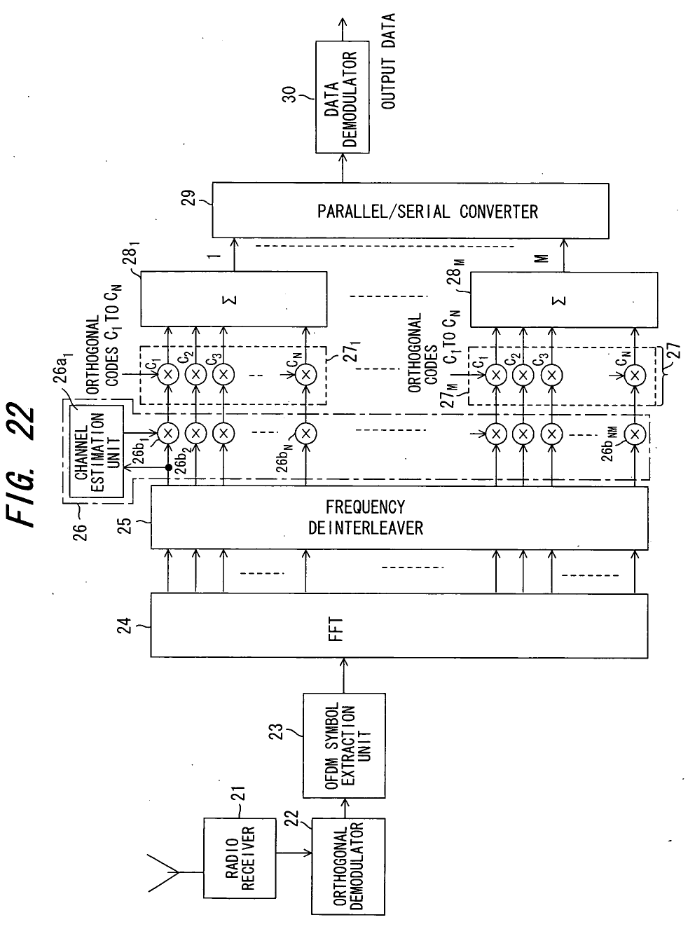

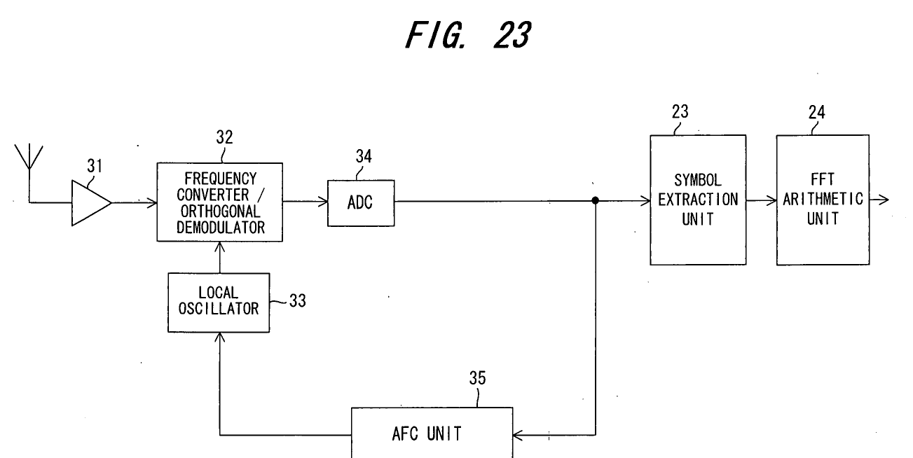

FIG. 12 is a block diagram for a case where frequency control is carried out by the second AFC unit. Here components identical with those shown in FIGS. 2 and 7 are designated by like reference characters. This embodiment differs in that the first AFC unit 57 is deleted and in that frequency control is performed by the second AFC unit 58 from the outset. The frequency control operation by the second AFC unit 58 is exactly the same as that of the case shown in FIG. 7. It should be noted that the arrangement shown in FIG. 9 can also be adopted as the second AFC unit 58 of FIG. 13.

Thus, in accordance with the present invention, frequency is controlled upon detecting a phase produced in a frame interval that is long in comparison with a symbol interval. As a result, even if the phase is small in the symbol interval, it can be enlarged in the frame interval and resolution can be improved. Moreover, S/N ratio can be improved by summing and the oscillation frequency of the receiving apparatus can be made to agree with that of the transmitting apparatus in highly accurate fashion.

Further, in accordance with the present invention, the S/N ratio can be improved further and the oscillation frequency of the receiving apparatus can be made to agree with that of the transmitting apparatus in highly accurate fashion in a short period of time by embedding frames with n-number of first to nth symbols having prescribed time profiles.

Further, in accordance with the present invention, frequency can be controlled up to a first precision at high speed by a first AFC unit, after which resolution and S/N ratio can be improved and frequency controlled in highly accurate fashion by a second AFC unit.

What is claimed is:

1. A frequency synchronizing method in an OFDM wireless system for synchronizing oscillation frequency of a receiving device to oscillation frequency of a transmitting device, comprising steps of:
receiving, from the transmitting device, frames in which symbols having identical time profiles have been embedded;
calculating a correlation value between the identical time profile portions in neighboring frames of a receive signal;
obtaining the phase of said correlation value as a frequency deviation between the transmitting device and the receiving device; and
controlling oscillation frequency based upon said phase.

2. A frequency synchronizing method according to claim 1, further comprising steps of:
successively calculating correlation values, in symbol intervals, between a receive signal that prevailed one frame earlier and a currently prevailing receive signal; and
adopting a peak correlation value, at which power of the correlation values peak, as said correlation value of said identical time profile portion.

3. A frequency synchronizing method according to claim 2, wherein symbols having said identical time profile are embedded in identical portions of each of the frames.

4. A frequency synchronizing method in an OFDM wireless system for synchronizing oscillation frequency of a receiving device to oscillation frequency of a transmitting device, comprising steps of:
receiving, from the transmitting device, frames in which n-number of first to nth symbols having prescribed time profiles have been embedded;
calculating and summing correlation values of n sets of corresponding time profile portions in neighboring frames of a receive signal;
obtaining the phase of said sum value as a frequency deviation between the transmitting device and the receiving device; and
controlling oscillation frequency based upon said phase.

5. A frequency synchronizing method according to claim 4, wherein said n-number of first to nth symbols are embedded in identical portions of each of the frames.

6. A frequency synchronizing method according to claim 4, wherein said n-number of first to nth symbols are embedded equidistantly in each of the frames.

7. A frequency synchronizing method according to claim 6, further comprising steps of:
successively calculating correlation values, in symbol intervals, between a receive signal that prevailed one frame earlier and a currently prevailing receive signal; and
summing corresponding correlation values at cycles of 1/n frame, obtaining a peak correlation value at which power peaks, and adopting this peak sum value as said sum value.

8. A frequency synchronizing method in an OFDM wireless system for synchronizing oscillation frequency of a receiving device to oscillation frequency of a transmitting device, comprising steps of:
receiving, from the transmitting device, frames having a plurality of symbols in which a guard interval has been inserted and in which symbols having identical time profiles have been embedded;
calculating a correlation value (a first correlation value) between a time profile in a guard interval and a time profile of a symbol portion that has been copied to a guard interval, obtaining the phase of said first correlation value as a frequency deviation between the transmitting device and the receiving device, and controlling oscillation frequency based upon said phase; and
when a predetermined condition holds, calculating a correlation value (a second correlation value) between identical time profile portions in mutually adjacent frames of a receiving signal, obtaining the phase of said second correlation value as a frequency deviation between the transmitting device and the receiving device, and controlling oscillation frequency based upon said phase.

9. A frequency synchronizing method according to claim 8, further comprising steps of:
successively calculating correlation values, over guard-interval widths, between a receive signal that prevailed one symbol earlier and a currently prevailing receive signal, and adopting a correlation value at which power peaks as said first correlation value; and
successively calculating correlation values, over symbol-interval widths, between a receive signal that prevailed one frame earlier and a currently prevailing receive signal, and adopting a correlation value at which power peaks as said second correlation value.

10. A frequency synchronizing method in an OFDM wireless system for synchronizing oscillation frequency of a receiving device to oscillation frequency of a transmitting device, comprising steps of:
receiving, from the transmitting device, frames having a plurality of symbols in which a guard interval has been inserted and in which n-number of first to nth symbols having prescribed time profiles have been embedded;
calculating a correlation value (a first correlation value) between a time profile in a guard interval and a time profile of a symbol portion that has been copied to a guard interval, obtaining the phase of said first correlation value as a frequency deviation between the transmitting device and the receiving device, and controlling oscillation frequency based upon said phase; and
when a predetermined condition holds, calculating and summing correlation values of n sets of corresponding time profile portions of two neighboring frames of a receive signal, obtaining the phase of said sum value as a frequency deviation between the transmitting device and the receiving device, and controlling oscillation frequency based upon said phase.

11. A frequency synchronizing method according to claim 10, further comprising steps of:
successively calculating correlation values, over guard-interval widths, between a receive signal that prevailed one symbol earlier and a currently prevailing receive signal, and adopting a correlation value at which power peaks as said first correlation value; and
when n-number of first to nth symbols have been embedded equidistantly in each of the frames, successively calculating correlation values, over symbol-interval widths, between a receive signal that prevailed one symbol earlier and a currently prevailing receive signal, summing corresponding correlation values at cycles of 1/n frame, obtaining a peak sum value at which power peaks, and adopting this peak sum value as said sum value.

12. A frequency synchronizing method according to claim 8, wherein said predetermined condition is assumed to hold when said phase has fallen below a set value or when a set period of time has elapsed since start of control.

13. A frequency synchronizing apparatus for synchronizing oscillation frequency of an OFDM receiving device to oscillation frequency of an OFDM transmitting device, comprising:
a receiving unit for receiving frames in which symbols having identical time profiles have been embedded;
a correlation arithmetic unit for calculating a correlation value between the identical time profile portions in neighboring frames of a receive signal;
a phase detector for obtaining the phase of said correlation value as a frequency deviation between the transmitting device and the receiving device; and
an oscillation frequency controller for controlling oscillation frequency based upon said phase.

14. A frequency synchronizing apparatus according to claim 13, wherein said correlation arithmetic unit has:
means for successively calculating correlation values, in symbol intervals, between a receive signal that prevailed one frame earlier and a currently prevailing receive signal; and
means for adopting a peak correlation value, at which correlation power peaks, as said correlation value of said identical time profile portion.

15. A frequency synchronizing apparatus for synchronizing oscillation frequency of an OFDM receiving device to oscillation frequency of an OFDM transmitting device, comprising:
a receiving unit for receiving frames in which n-number of first to nth symbols having prescribed time profiles have been embedded;
a correlation arithmetic unit for calculating and summing correlation values of n sets of corresponding time profile portions in neighboring frames of a receive signal;
a phase detector for obtaining the phase of said sum value as a frequency deviation between the transmitting device and the receiving device; and
an oscillation frequency controller for controlling oscillation frequency based upon said phase.

16. A frequency synchronizing apparatus according to claim 15, wherein said correlation arithmetic unit has:
means for successively calculating correlation values, in symbol intervals, between a receive signal that prevailed one frame earlier and a currently prevailing receive signal in a case where n-number of first to nth symbols have been embedded equidistantly in each of the frames;
a summing unit for summing corresponding correlation values at cycles of 1/n frame; and
means for adopting a sum value at which power peaks as said sum value.

17. A frequency synchronizing apparatus for synchronizing oscillation frequency of an OFDM receiving device to oscillation frequency of an OFDM transmitting device, comprising:
a receiving unit for receiving frames having a plurality of symbols in which a guard interval has been inserted and in which symbols having identical time profiles have been embedded;
first frequency control means for calculating a correlation value (a first correlation value) between a time profile in a guard interval and a time profile of a symbol portion that has been copied to a guard interval, obtaining the phase of said first correlation value as a frequency deviation between the transmitting device and the receiving device, and controlling oscillation frequency based upon said phase;
second frequency control means for calculating a correlation value (a second correlation value) between identical time profile portions in mutually adjacent frames of a receiving signal, obtaining the phase of said second correlation value as a frequency deviation between the transmitting device and the receiving device, and controlling oscillation frequency based upon said phase; and
control changeover means for changing over frequency control to the second frequency control means when said phase has fallen below a set value by control performed by the first frequency control means or when a set period of time has elapsed since start of control by the first frequency control means.

18. A frequency synchronizing apparatus according to claim 17, wherein said first frequency control means successively calculates correlation values, over guard-interval widths, between a receive signal that prevailed one symbol earlier and a currently prevailing receive signal, obtains a correlation value at which power peaks as said first correlation value, and obtains the phase of said first correlation value as a frequency deviation between the transmitting device and the receiving device; and
said second frequency control means successively calculates correlation values, over symbol-interval widths, between a receive signal that prevailed one frame earlier and a currently prevailing receive signal, obtains a correlation value at which power peaks as said second correlation value, and obtains the phase of said second correlation value as a frequency deviation between the transmitting device and the receiving device.

19. A frequency synchronizing apparatus for synchronizing oscillation frequency of an OFDM receiving device to oscillation frequency of an OFDM transmitting device, comprising:
a receiving unit for receiving frames having a plurality of symbols in which a guard interval has been inserted and in which n-number of first to nth symbols having prescribed time profiles have been embedded;
first frequency control means for calculating a correlation value (a first correlation value) between a time profile in a guard interval and a time profile of a symbol portion that has been copied to a guard interval, obtaining the phase of said first correlation value as a frequency deviation between the transmitting device and the receiving device, and controlling oscillation frequency based upon said phase;
second frequency control means for calculating and summing correlation values of n sets of corresponding time profile portions of two neighboring frames of a receive signal, obtaining the phase of said sum value as a frequency deviation between the transmitting device and the receiving device and controlling oscillation frequency based upon said phase; and
control changeover means for changing over frequency control to the second frequency control means when said phase has fallen below a set value by control performed by the first frequency control means or when a set period of time has elapsed since start of control by the first frequency control means.

20. A frequency synchronizing apparatus according to claim 19, wherein said first frequency control means successively calculates correlation values, over guard-interval widths, between a receive signal that prevailed one symbol earlier and a currently prevailing receive signal, obtains a correlation value at which power peaks as said first correlation value, and obtains the phase of said first correlation value as a frequency deviation between the transmitting device and the receiving device; and
said second frequency control means successively calculates correlation values, over symbol-interval widths, between a receive signal that prevailed one frame earlier and a currently prevailing receive signal in a case where n-number of first to nth symbols have been embedded equidistantly in each of the frames, sums corresponding correlation values at cycles of 1/n frame, adopts a peak sum value at which power peaks as said sum value and obtains the phase of said peak sum value as a frequency deviation between the transmitting device and the receiving device.
